(19) United States
(12) Patent Application Publication
(10) Pub. No.: US 2015/0271452 A1
(43) Pub. Date: Sep. 24, 2015

(54) VEHICLE-BASED MEDIA CONTENT CAPTURE AND REMOTE SERVICE INTEGRATION

(71) Applicant: Ford Global Technologies, LLC, Dearborn, MI (US)

(72) Inventor: Christian Castro GUZMAN, Naucalpan (MX)

(73) Assignee: Ford Global Technologies, LLC, Dearborn, MI (US)

(21) Appl. No.: 14/221,360

(22) Filed: Mar. 21, 2014

(51) Int. Cl. H04N 7/18; H04N 1/00; B60R 1/00; H04N 7/20

(52) U.S. Cl. CPC H04N 7/181; H04N 7/20; H04N 1/00106; H04N 1/00116; B60R 1/00; H04N 2101/00

(57) ABSTRACT

A vehicle may include at least one media content capture device. The vehicle may further include a controller in communication with the at least one media content capture device and configured to, responsive to a user request, capture a media content instance using the at least one media content capture device according to media content capture settings of the vehicle, and post the media content instance to an account of a remote service associated with the vehicle.

### TECHNICAL FIELD

The illustrative embodiments generally relate to capture of media content instances by media capture devices integrated with a vehicle, as well as to transfer of the captured media content instances to a remote service.

### BACKGROUND

Some vehicles include a rear-facing camera system that provides an image of what is behind the vehicle to a display screen. Some off-road vehicles include a front-facing camera system, to provide an image of a trail ahead and what obstacles should be avoided. These systems may further include guidelines in the displayed image to show, based on steering position, where the vehicle may be headed in the image, as well as collision avoidance measures that perform automatic brake application when a collision is imminent.

### SUMMARY

In a first illustrative embodiment, a vehicle includes at least one media content capture device; and a controller in communication with the at least one media content capture device and configured to responsive to a user request, capture a media content instance using the at least one media content capture device according to media content capture settings of the vehicle, and post the media content instance to an account of a remote service associated with the vehicle.

In a second illustrative embodiment, a method includes responsive to a user request, capturing, by a controller of a vehicle in communication with at least one media content capture device of the vehicle, a media content instance using the at least one media content capture device of the vehicle according to media content capture settings of the vehicle, and posting the media content instance to an account of a remote service associated with the vehicle.

In a third illustrative embodiment, a non-transitory computer-readable medium includes instructions that when executed by a controller of a vehicle are configured to cause the controller to responsive to a user request, capture, by the controller in communication with at least one media content capture device of the vehicle, a media content instance using the at least one media content capture device of the vehicle according to media content capture settings of the vehicle, and post the media content instance to an account of a remote service associated with the vehicle.

### BRIEF DESCRIPTION OF THE DRAWINGS

FIG. 1 is an exemplary block topology of a vehicle infotainment system implementing a user-interactive vehicle based computing system;

FIG. 2 illustrates an exemplary vehicle having media capture devices and in communication with a remote service via the network;

FIG. 3 illustrates an exemplary vehicle infotainment system configured to receive requests to capture media content instances;

FIG. 4 illustrates an exemplary user interface including a control configured to request capture of the media content instances;

FIG. 5 illustrates an exemplary user interface including controls configured to allow for transfer and posting of captured media content instances; and

FIG. 6 illustrates an exemplary process for capturing media content instances.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Rear-facing and forward-facing imaging systems may provide drivers with information about their surroundings. However, the cameras used in such systems may be limited in resolution, light sensitivity, and focal length. Moreover, such imaging systems may be limited in ability to store the captured images, and may lack connectivity to vehicle telematics systems or to beyond the vehicle to remote network services.

An improved vehicle media capture system may include one or more media capture devices integrated into the vehicle and configured to allow a driver or other user to capture and store media content instances. The media capture devices may include, for example a front-facing camera mounted at a front of the vehicle such as behind the front grill, and a rear-facing camera mounted at a rear of the vehicle, such as on a rear trunk lid. The captured media content instances may include, as some examples, still pictures, video content, and/or audio content.

The media content instances may be captured by the vehicle when the vehicle is moving or stationary, and media content capture may be triggered by a user inside or outside of the vehicle. For example, the system may provide a dedicated button in the vehicle cabin or command within a touchscreen interface of the vehicle to allow for activation of one or more of the cameras to capture a media content instance. As another example, the system may provide a command that may be sent from the smartphone of the user, to cause the vehicle to capture the media content instance. The system may further be configured to provide metadata in the captured media content instance describing the circumstances of the capture, such as data and time, geographic location, and identifier of the vehicle that performed the capture.

Once captured, the system may be used to manage the captured media content instances. For example, the system may allow the user to browse, delete, arrange, and otherwise manipulate the captured media content instances. The system may further allow the user to share the media content instances with social media (e.g., to an account linked to the identifier of the vehicle), or transfer the media content to other devices in communication with the system, such as to the user's mobile device or connected flash drive.

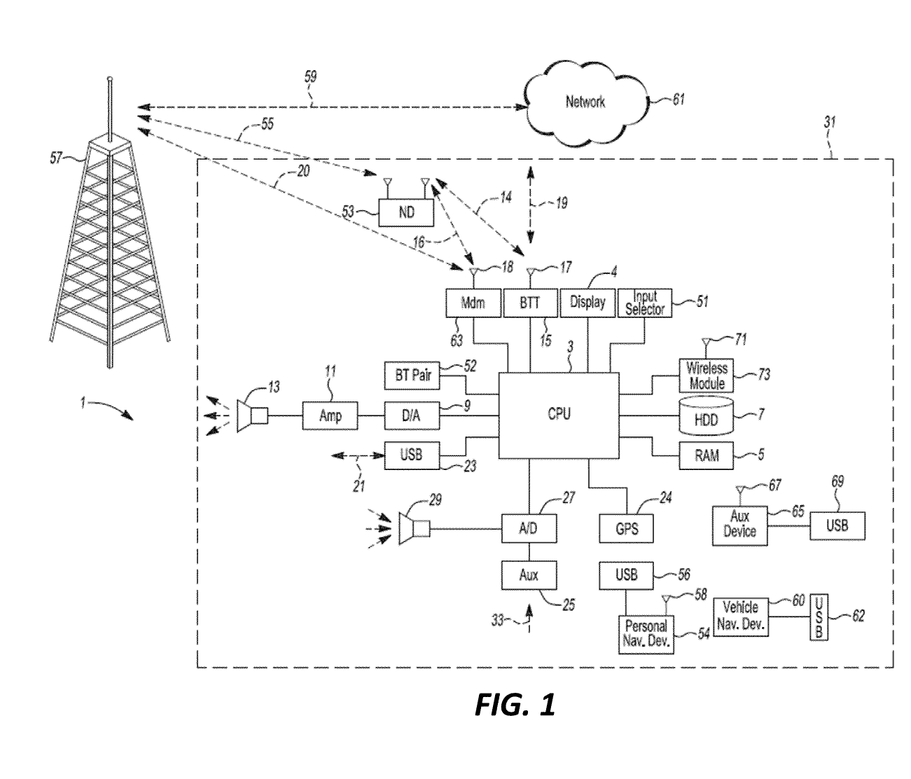

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

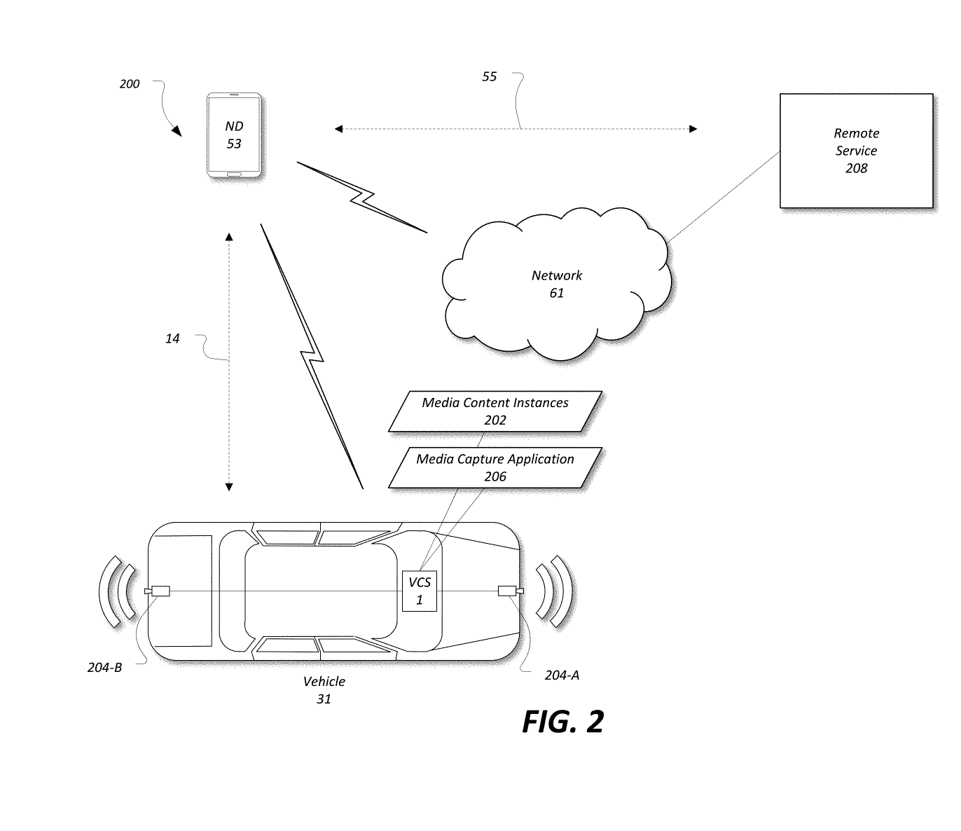

FIG. 2 illustrates an exemplary vehicle 31 having media capture devices 204-A and 204-B (collectively 204) and in communication with a remote service 208 via the network 61. As one possibility, the VCS 1 of the vehicle 31 may be connected to a paired nomadic device 53 (e.g. via BLUETOOTH), such that the communications features of the nomadic device 53 may be used to allow the VCS 1 to communicate via the network 61 with the remote service 208. The VCS 1 may be further configured to execute a media capture application 206 to cause the media capture devices 204 to capture media content instances 202, as well as to provide the media content instances 202 to the remote service 208 by way of the network 61.

A media content instance 202 may refer to a still picture or image, video content, audio content, or any other digital or analog media content captured in a computer-readable format. In some cases, the media content instance 202 may include both audio content and video content. In other cases, the media content instance 202 may include audio content but not video content, or video content but not audio content. In many cases, the media content instances 202 may further be associated with metadata descriptive of the content of the media content instances 202, such as: a geographical location at which the media content instance 202 was captured (e.g., GPS coordinates, point-of-interest identifier, an identifier of a cellular tower 57 to which the nomadic device 53 paired to the VCS 1 was connected, etc.), a date and time at which the media content instance 202 was captured, information regarding the vehicle 31, user, or devices performing the capture (e.g., a vehicle identification number (VIN) uniquely identifying the vehicle 31, an identifier of a user account to the VCS 1 associated with the vehicle 31, an identifier of a user account of a nomadic device 53 paired with the VCS 1, a phone number associated with the vehicle or paired device, etc.), and information regarding the format of the captured content (e.g., image resolution, frame rate, image rate, codecs in which the content is encoded, etc.), as some examples.

The media capture devices 204 may include any of various types of devices configured to capture media content instances 202. In an example, the media capture device 204 may be a GoPro extreme sports camera distributed by Woodman Labs of San Mateo, Calif. Other types of media capture devices 204 may include microphones to capture audio content, such as microphone 29 of the VCS 1 or one or more other microphones external to the vehicle cabin. In some cases, a media capture device 204 may be configured to capture a single type of media content instance 202 (e.g., video, audio, still pictures, etc.), while in other cases the media capture device 204 may be able to capture multiple types of media content instance 202 (e.g., both audio and video). The vehicle 31 may include one or more media capture devices 204. As illustrated, the vehicle 31 includes a front-mounted media capture device 204-A configured to capture media content instances 202 in front of the vehicle 31, and a rear-mounted media capture device 204-B configured to capture media content instances 202 behind the vehicle 31. The front-mounted media capture device 204-A may be mounted at various frontal locations, such as behind a front grill of the vehicle 31, inside the vehicle 31 at the top of the front windshield facing forwards, on a roof rack facing forwards, etc. The rear-mounted media capture device 204-B may be mounted at various rearward locations, such as above a license plate, on a rear trunk lid, incorporated into a rear bumper, and inside the vehicle facing out a rear windshield, as some possibilities. It should be noted that the illustrated count and location of media capture devices 202 is merely exemplary, and more, fewer, and/or differently located media capture device 204 may be used as well.

The VCS 1 of the vehicle 31 may be utilized to control the media capture devices 204. For example, a media capture application 206 installed on a vehicle memory 5 or 7 may be configured to send requests to media capture devices 204 to capture media content instances 202, and to receive the media content instances 202 from the media capture devices 204 in response. The VCS 1 may be further configured to include the metadata information, and store the captured media content instances 202. In an example, the media content instances 202 may be stored on the vehicle memory 5 or 7 of the VCS 1. As another possibility, the VCS 1 may store the captured media content instances 202 on a USB flash drive connected to the USB input 23 of the VCS 1.

The VCS 1 of the vehicle 31 may be further utilized to facilitate the posting of captured media content instances 202 from the storage of the VCS 1 to the remote service 208. For instance, the media capture application 206 may be configured to cause the VCS 1 to post the media content instances 202 to the remote service 208 where the media content instances 202 may be stored in a data store for later retrieval by users of the service 208. In some examples, the VCS 1 may be configured to automatically upload the captured media content instances 202 to the remote service 208, while in other cases the VCS 1 may be configured to upload the captured media content instances 202 upon receiving input directing the VCS 1 to do so (e.g., via user responding affirmatively to a query to post the captured media content instance 202 upon its capture, via a media content instance 202 management user interface opting to post selected content, etc.).

In some cases, the media content instances 202 may be posted to an account of the service 208 associated with the vehicle 31. For instance, the vehicle 31 may be configured to post the captured media content instances 202 to a vehicle content remote service 208 designed to host media content instances 202 captured by vehicles 31. As some other possibilities, the remote service 208 may be a social network such as the Facebook social networking website maintained by Facebook, Inc. of Melno Park, Calif., the Twitter online social networking and blogging service maintained by Twitter, Inc. of San Francisco, Calif., the Tumblr blogging and social networking website maintained by Yahoo! Inc. of Sunnyvale, Calif., the Yammer social networking website maintained by the Yammer, Inc. subsidiary of Microsoft, Inc. of Redmond, Wash., or a media storage website such as the Flickr image and video hosting service maintained by Yahoo! Inc. of Sunnyvale, Calif., the Instagram photo sharing, video sharing and social networking service maintained by Facebook, Inc. of Melno Park, Calif., the Photobucket image hosting and video hosting website maintained by Photobucket, Inc. of Denver, Colo., the Vine video hosting and social networking mobile application maintained by Twitter, Inc. of San Francisco, Calif., and the Vimeo video-sharing website maintained by Vimeo, LLC subsidiary of InterActiveCorp of New York City, N.Y.

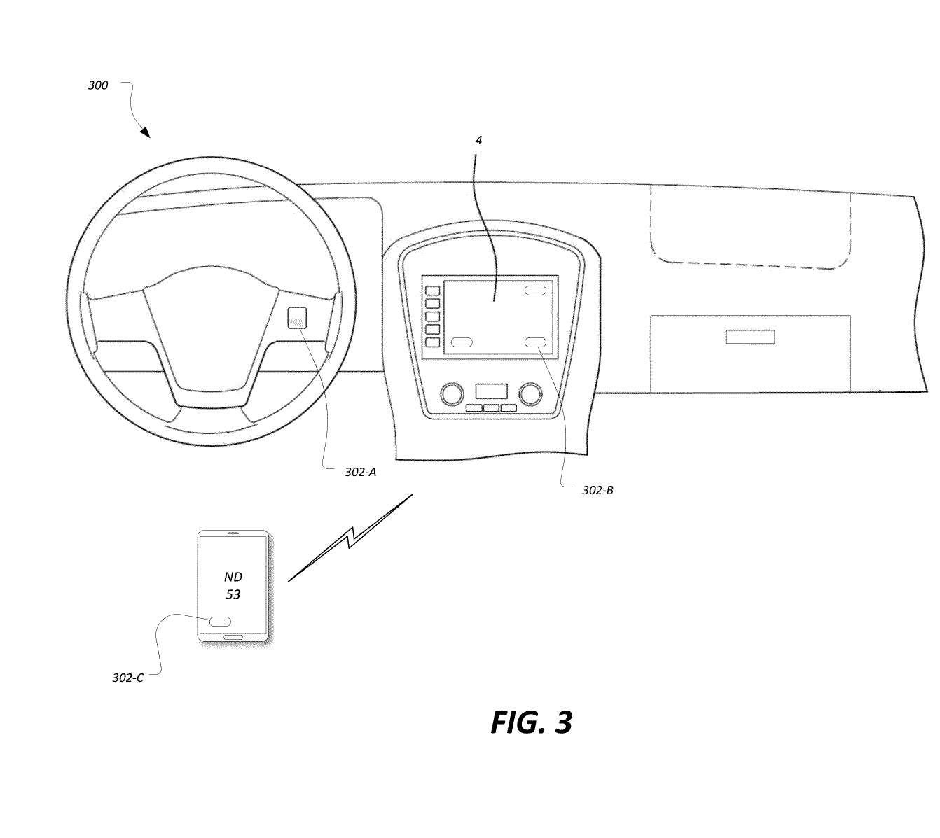

In some examples, the vehicles 31 may post their captured media content instances 202 to an account of the remote service 208 associated with an identifier of the vehicle 31 (e.g., to an account identified at least in part by the vehicle 31 VIN, to a user telematics account of the driver associated with the VCS 1, etc.). As some other possibilities, the vehicles 31 may post their captured media content instances 202 to an account of the remote service 208 associated with an identifier of a user account of a nomadic device 53 paired with the VCS 1, a phone number associated with the vehicle or paired nomadic device 53, a remote service 208 account previously set up with the VCS 1 or nomadic device 53 for posting, etc.). Further aspects of the capture and manipulation of media content instances 202 are discussed in detail below with respect to the FIGS. 3-6.

FIG. 3 illustrates an exemplary VCS 1 configured to receive requests to capture media content instances 202. A request to capture a media content instance 202 may be initiated by a driver or other user in various ways. As one possibility, the request to capture a media content instance 202 may be initiated by the user interacting with a physical control 302-A located within the vehicle 31 cabin. As illustrated, the physical control 302-A may be a steering-wheel mounted button, however other locations or types of control are possible. In another example, the physical control 302-A may be a button positioned on the center console or armrest within reach of the driver.

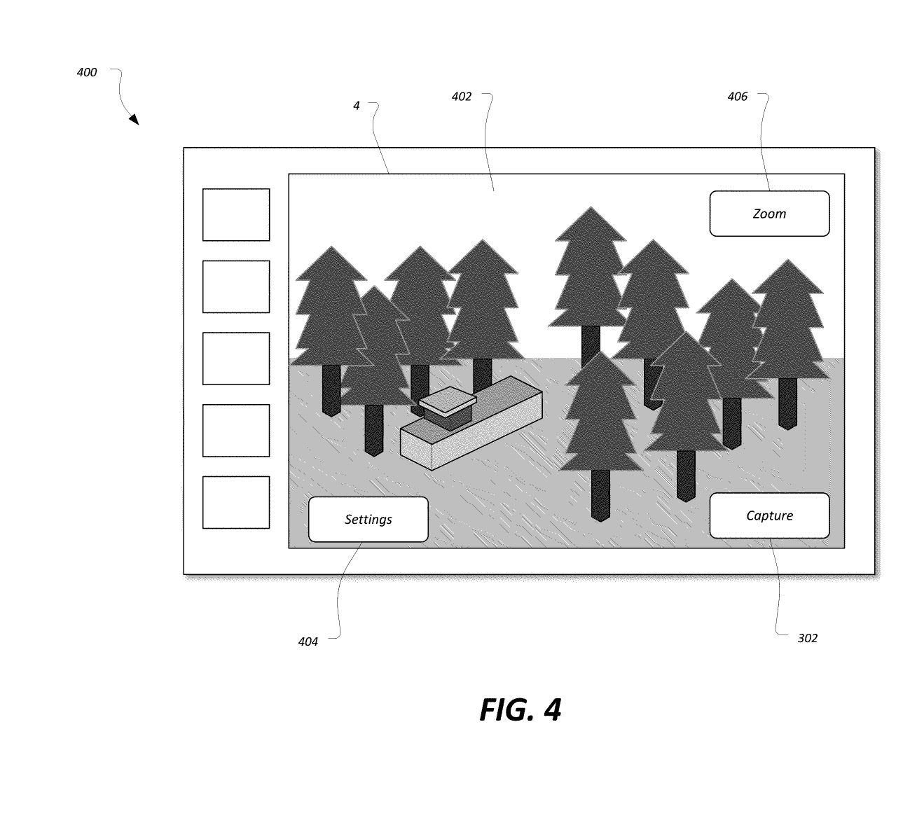

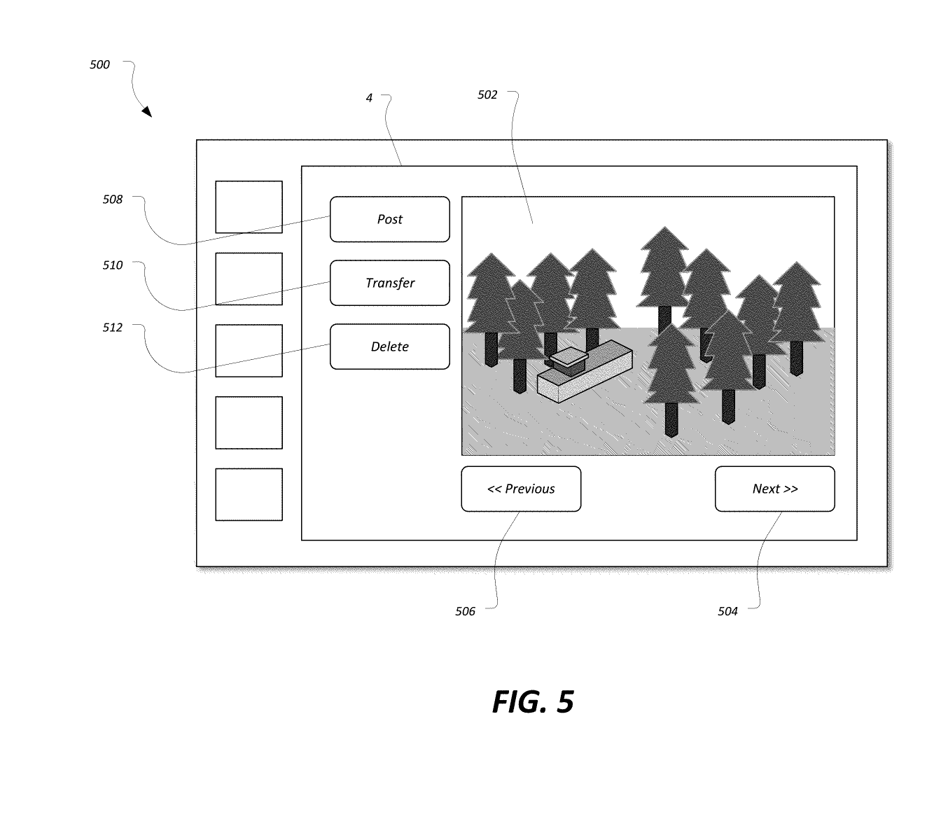

As another possibility, the request to capture a media content instance 202 may be initiated by the user pressing a touchscreen control 302-B or by otherwise providing touch input to the VCS 1 via a touchscreen interface of the VCS 1. As illustrated, the media capture application 206 may be configured to provide a user interface via the display 4 of the head unit of the VCS 1, where the user interface includes a touchscreen control 302-B that, when selected, may invoke a capture function of the VCS 1. Aspects of an exemplary display user interface are discussed in detail below with respect to FIGS. 4 and 5.

As a further possibility, the request may be initiated by the user providing a voice command to an audio interface of the VCS 1, rather than via a physical control or touch control. For instance, the user may press a push-to-talk or other control within the vehicle 31 configured to initiate VCS 1 capture of voice commands, and the user may provide a voice command requesting that the media content instance 202 be captured. The voice command to trigger capture of the media content instance 202 may be included in the VCS 1 vocabulary of recognized voice commands by the media capture application 206, for example.

As yet another possibility, the request may be initiated by user input to the nomadic device 53. For instance, the request to capture a media content instance 202 may be initiated by the user pressing a touchscreen control 302-C or by providing other input to the nomadic device 53 in communication with the VCS 1 (e.g., physical button input, voice input, etc.). To do so, the nomadic device 53 may be configured to execute a component of the media capture application 206 configured to provide the user interface as well as to send the request to the VCS 1 of the vehicle 31 requesting that the media content instance 202 be captured.

The request may be provided from the nomadic device 53 to the vehicle 31 in various ways, such as via a direct connection between the nomadic device 53 and the vehicle 31, or via another network 61 connection to the vehicle 31. For instance, the nomadic device 53 may provide the request to the vehicle 31 via a BLUETOOTH or WiFi connection between the nomadic device 53 and the vehicle 31. Or, the nomadic device 53 may send a short message service (SMS) message to the vehicle 31 via the network 61. As another possibility, the nomadic device 53 may be configured to send a request to a telematics vehicle service configured to provide commands to vehicle 31 via the network 61. This vehicle service may be otherwise used by the VCS 1 to receive other telematics commands, for example, to receive requests to lock or unlock vehicle doors or to receive firmware updates. Responsive to the nomadic device 53 request, the vehicle service may validate that the nomadic device 53 is authorized to command the VCS 1 of the specific vehicle 31 (e.g., by VIN or other account identifier), and if so provide the request to the vehicle 31 to request the capture of the media content instance 202. Accordingly, use of the nomadic device 53 to request capture of media content instances 202 may allow the user to request the vehicle 31 to capture media content instances 202 while outside of the vehicle 31.

FIG. 4 illustrates an exemplary user interface 400 including a control 302-A configured to request capture of the media content instances 202. The user interface 400 may be presented, for example, on a display 4 of the head unit of the VCS 1 by the media capture application 206. As another possibility, the user interface 400 may be presented by the media capture application 206 on a display of the nomadic device 53.

As illustrated, the user interface 400 includes a preview 402 of the media content instance 202 to be captured. The preview 402 may be configured to allow the user to determine whether the media capture device 204 of the vehicle 31 is capturing the correct content. In some cases, where the user interface 400 is displayed via the nomadic device 53, the preview 402 may be omitted or may require selection of a preview control of the vehicle 31 to cause preview data to be provided from the vehicle 31 to the nomadic device 53 (e.g., via the connections between the vehicle 31 and nomadic device 53 discussed above).

The user interface 400 also includes a settings control 404, that, when selected, may cause the media capture application 206 to offer a user interface including settings with respect to the capture of media content instances 202. These settings may include, as some examples: which of the media capture devices 204 of the vehicle 31 is being selected for use in the capture of the media content instance 202, what aspects of media content are to be captured (e.g., one or more of still image, video, audio, etc.), an amount of delay between the request and the capture of the media content instance 202, a length of video to capture, what codecs to use to encode the captured media content instance 202, and a level of quality to use when capturing the media content instance 202 (e.g., an image resolution, an amount of audio or video compression to perform, etc.).

It should be noted that the settings may provide for multiple media capture devices 204 of the vehicle 31 to be selected and configured for substantially simultaneous use. For example, the settings may be configured to select multiple audio media capture devices 204 (e.g., to provide for a stereo capture). As another possibility, the settings may provide for the capture of video from multiple image or video media capture devices 204 (e.g., to provide for the capture of a three-dimensional video or image, to provide for the capture of a wider field of view than possible from a single media capture device 204, to provide for the capture of multiple views at the same time such as a view from the front and the rear of the vehicle 31, etc.). As yet a further possibility, the settings may provide for media capture of multiple types of media content (such as audio and video), which, depending on the capabilities of the media capture devices 204, may require the use of multiple media capture devices 204 to perform. For instance, the settings may utilize one media capture device 204 to capture audio content, and another media capture device 204 to capture video content.

The user interface 400 may further include a zoom control 406 configured to allow the user to select between greater field of view from a selected media capture device 204 of the vehicle 31 and greater detail within the field of view. As one possibility, when selected the zoom control 406 may cause the media capture application 206 to offer a user interface including a selection of various levels of zoom to be applied to the media capture device 204.

The user interface 400 may also include a capture control 302 (i.e., the capture control 302-B discussed in detail above). When selected, the capture control 302 may be configured to provide a request to the VCS 1 to cause the VCS 1 to capture a media content instance 202 using the selected settings and media capture device 204.

In some cases, when audio or video content is being captured, the user interface 400 may provide a stop capture user interface control that may be selected to discontinue capture of the media content instance 202. As one possibility, the capture control 302 may change to a stop capture control once capture has begun, and may change back to the capture control 302 when capture is completed. As another possibility, the capture settings may specify a length of media content instance 202 to be captured.

Once captured, the media content instance 202 may be saved by the VCS 1. In an example, the media content instances 202 may be stored on a memory 5 or 7 of the VCS 1. As another possibility, the VCS 1 may store the captured media content instances 202 to a USB flash drive connected to the USB input 23 of the VCS 1. In some cases, the user interface 400 may further provide a confirmation function to allow for the discarding or recapture of media content instances 202 that are captured before they are saved.

FIG. 5 illustrates an exemplary user interface 500 provided by the display 4 of the VCS 1 and including controls configured to allow for transfer and posting of captured media content instances 202. Similar to as discussed above with respect to the user interface 400, the user interface 500 may be presented, for example, on a display 4 of the head unit of the VCS 1 or, in other examples, on a display of the nomadic device 53.

As illustrated, the user interface 500 includes a presentation 502 of the currently displayed media content instance 202, as well as controls configured to allow the user to browse among the other media content instances 202 captured by the VCS 1. As one possibility, the user interface 500 may include a next control 504 that, when selected, is configured to cause the VCS 1 to browse to the next of an ordered set of stored media content instance 202, and a previous control 506 that, when selected, is configured to cause the VCS 1 to browse to the previous of the ordered stored media content instance 202. The ordering of the media content instances 202 may be done in various ways, such as by capture date and time, by geographic location, or by some other metadata attribute or attributes of the stored media content instances 202.

The user interface 500 may also include additional controls that may be used to allow for the posting of captured media content instances 202. As one possibility, the user interface 500 may include a post control 508 that, when selected, may be configured to cause the VCS 1 to provide the media content instance 202 displayed in the presentation 502 to an account of the remote service 208. In an example, when selected, the post control 508 may be configured to cause the VCS 1 provide the media content instance 202 to a social networking account of the user (such as to a Facebook or Instagram account of the user, or to an account of a vehicle content remote service 208 designed to host media content instances 202 captured by vehicles 31).

The user interface 500 may also include additional controls that may be used to allow for the transfer of captured media content instances 202. As one possibility, the user interface 500 may include a transfer control 510 that, when selected, may be configured to cause the VCS 1 to provide the media content instance 202 displayed in the presentation 502 (or, e.g., to sync all media content instances 202) to a connected USB flash drive or to the nomadic device 53 paired with the VCS 1.

The user interface 500 may further include additional controls, such as a delete control 512 that, when selected, is configured to cause the VCS 1 to delete the media content instance 202 displayed in the presentation 502 from VCS 1 storage.

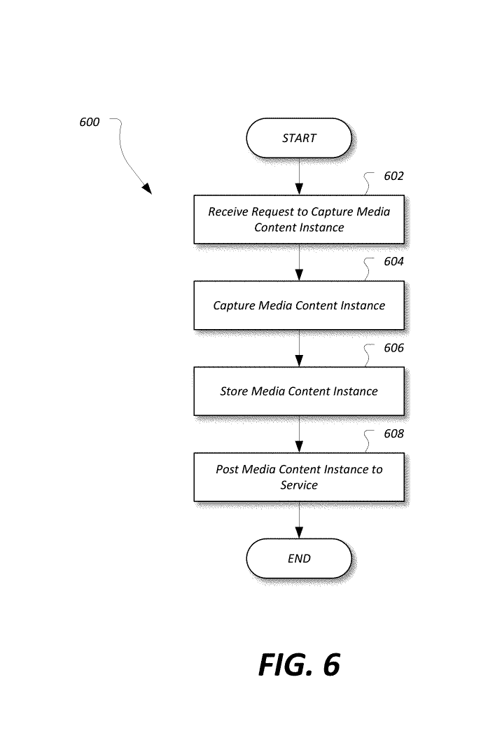

FIG. 6 illustrates an exemplary process 600 for capturing media content instances 202. As one possibility, the process 600 may be implemented by a media capture application 206 installed on a memory 5 or 7 and executed by the CPU 3 contained within the VCS 1. In other embodiments, the process 600 may be implemented in other controllers or devices (such as the nomadic device 53), or distributed amongst multiple vehicle 31 controllers such as the VCS 1 and/or the head unit of the VCS 1.

At block 602, the VCS 1 receives a request to capture a media content instance 202. For example, the user interface 400 may include a capture control 302-B that, when selected, is configured to provide a request to the VCS 1 to cause the VCS 1 to capture a media content instance 202 using the selected settings and media capture device 204. As another example, the request to capture the media content instance 202 may be initiated by the user interacting with a physical control 302-A located in the vehicle 31 cabin. As a further example, the request to capture a media content instance 202 may be initiated by the user pressing a touchscreen control 302-C or by providing other input to the nomadic device 53 in communication with the VCS 1. As an even further possibility, the request may be initiated by the user providing a voice command to an audio interface of the VCS 1 or nomadic device 53, rather than via a physical control or touch control.

At block 604, the VCS 1 captures the media content instance 202. For example, responsive to receipt of the request to capture the media content instance 202, the VCS 1 may be configured to cause the media capture device 204 indicated by the VCS 1 settings to capture the media content instance 202 as specified by the VCS 1 settings. These VCS 1 settings may include, for example, what aspects of media content are to be captured (e.g., still image, video, audio, etc.), an amount of delay between requesting capture of the media content instance 202 and capture of the media content instance 202, a length of video to capture, what codecs to use to encode the captured media content instance 202, and a level of quality to use when capturing the media content instance 202 (e.g., an image resolution, an amount of compression to perform, etc.).

At block 606, the VCS 1 stores the media content instance 202. In an example, the media content instances 202 may be stored on a memory 5 or 7 of the VCS 1. As another possibility, the VCS 1 may store the captured media content instances 202 to a USB flash drive connected to the USB input 23 of the VCS 1.

At block 608, the VCS 1 posts the media content instance 202 to the remote service 208. In some examples, the vehicles 31 may post their captured media content instances 202 to an account of the remote service 208 associated with an identifier of the vehicle 31 (e.g., to an account identified at least in part by the vehicle 31 VIN, to a user telematics account of the driver associated with the VCS 1, etc.). As some other possibilities, the vehicles 31 may post their captured media content instances 202 to an account of the remote service 208 associated with an identifier of a user account of a nomadic device 53 paired with the VCS 1, a phone number associated with the vehicle or paired nomadic device 53, a remote service 208 account previously set up with the VCS 1 or nomadic device 53 for posting, etc.). In an example, responsive to receipt of an indication of user selection of a post control 508 of the user interface 500, the VCS 1 may be configured to provide the media content instance 202 displayed in the presentation 502 to an account of the remote service 208. As another possibility, captured media content instances 202 may be automatically provided by the VCS 1 to the remote service 208. Transfer to the remote service 208 may be performed, for example, by way of transfer of the media content instance 202 to the nomadic device 53 via the VCS 1 connection to the nomadic device 53, and further via the data plan connection of the nomadic device 53 to the network 61. In an example, when selected, the post control 508 may be configured to cause the VCS 1 provide the media content instance 202 to a social networking account of the user (such as to a Facebook or Instagram account of the user, or to an account of a vehicle content remote service 208 designed to host media content instances 202 captured by vehicles 31). After block 608, the process 600 ends.

Thus, the VCS 1 of the vehicle 31 be configured to allow a user to capture media content instances 202 via media capture devices 204 of the vehicle 31, and share the captured media content instances 202 with remote services 208 such as social media as well as transfer the media content instances 202 to other devices in communication with the system. Accordingly, the user may be able to capture pictures using his or her vehicle 31 and quickly share those captured media content instances 202 with social networking friends or other people.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle comprising:
at least one media content capture device; and
a controller in communication with the at least one media content capture device and configured to:
responsive to a user request, capture a media content instance using the at least one media content capture device according to media content capture settings of the vehicle, and
post the media content instance to an account of a remote service associated with the vehicle.

2. The vehicle of claim 1, wherein the controller is further configured to store the media content instance on a persistent memory of the controller.

3. The vehicle of claim 1, wherein the controller is further configured to receive the request to capture the media content instance from a nomadic device associated with the user and in communication with the vehicle.

4. The vehicle of claim 3, wherein the request is provided to the vehicle via at least one of: (i) a short message service message from the nomadic device to a modem of the vehicle, (ii) a network device configured to provide the request to the vehicle responsive to a request received from the nomadic device, and (iii) via a direct network connection between the nomadic device to the vehicle.

5. The vehicle of claim 1, wherein the media content capture settings include an indication of which of the at least one media content capture device to use to capture the media content instance.

6. The vehicle of claim 1, wherein the media content instance further includes metadata including an identifier of the vehicle.

7. The vehicle of claim 1 wherein the media content instance further includes metadata including a geographic location of the vehicle when the media content instance was captained, and a date and time at which the media content instance was captured.

8. A method comprising:
responsive to a user request, capturing, by a controller of a vehicle in communication with at least one media content capture device of the vehicle, a media content instance using the at least one media content capture device of the vehicle according to media content capture settings of the vehicle, and
posting the media content instance to an account of a remote service associated with the vehicle.

9. The method of claim 8, further comprising storing the media content instance on a persistent memory of the controller.

10. The method of claim 8, further comprising receiving the request to capture the media content instance from a nomadic device associated with the user and in communication with the vehicle.

11. The method of claim 10, further comprising receiving the user request according to at least one of: (i) a short message service message from the nomadic device to a modem of the vehicle, (ii) a network device providing the request to the vehicle responsive to a request received from the nomadic device, and (iii) via a direct network connection between the nomadic device to the vehicle.

12. The method of claim 8, wherein the media content capture settings include an indication of which of the at least one media content capture device to use to capture the media content instance.

13. The method of claim 8, further comprising including metadata in the media content instance including: an identifier of the vehicle, a geographic location of the vehicle when the media content instance was captained, and a date and time at which the media content instance was captured.

14. A non-transitory computer-readable medium including instructions that when executed by a controller of a vehicle are configured to cause the controller to:
responsive to a user request, capture, by the controller in communication with at least one media content capture device of the vehicle, a media content instance using the at least one media content capture device of the vehicle according to media content capture settings of the vehicle, and
post the media content instance to an account of a remote service associated with the vehicle.

15. The computer-readable medium of claim 14, further including instructions configured to cause the controller to store the media content instance on a persistent memory of the controller.

16. The computer-readable medium of claim 14, further including instructions configured to cause the controller to receive the request to capture the media content instance from a nomadic device associated with the user and in communication with the vehicle.

17. The computer-readable medium of claim 16, further including instructions configured to cause the controller to receive the user request according to at least one of: (i) a short message service message from the nomadic device to a modem of the vehicle, (ii) a network device providing the request to the vehicle responsive to a request received from the nomadic device, and (iii) via a direct network connection between the nomadic device to the vehicle.

18. The computer-readable medium of claim 14, wherein the media content capture settings include an indication of which of the at least one media content capture device to use to capture the media content instance.

19. The computer-readable medium of claim 14, further including instructions configured to cause the controller to include metadata in the media content instance including: an identifier of the vehicle, a geographic location of the vehicle when the media content instance was captained, and a date and time at which the media content instance was captured.

20. The computer-readable medium of claim 14, further including instructions configured to cause the controller to upload the media content instance to an account of a vehicle content remote service configured to host media content instances captured by vehicles, the account of the vehicle content remote service being identified by the controller to the vehicle content remote service based at least in part on vehicle identification number (VIN).
